(19) United States
(12) Patent Application Publication
(10) Pub. No.: US 2011/0053124 A1
(43) Pub. Date: Mar. 3, 2011

(54) ENGLISH LEARNING APPARATUS AND SYSTEM FOR SUPPORTING MEMORIZATION OF WORDS USING PICTURES

(76) Inventor: Sungeun JUNG, Seoul (KR)

(21) Appl. No.: 12/860,170

(22) Filed: Aug. 20, 2010

(30) Foreign Application Priority Data
Aug. 28, 2009 (KR) 10-2009-0080326

(51) Int. Cl. G09B 19/06

(52) U.S. Cl. 434/157

(57) ABSTRACT

Disclosed herein is an English learning apparatus and system for supporting the memorization of words using pictures. The English learning system includes a server for providing a user-created word list, and an English learning apparatus for supporting memorization of words using pictures. The English learning apparatus includes a local storage unit for storing a user-created word list and an English word list. A local communication unit receives the user-created word list from the second server storage unit, and stores the user-created word list in the local storage unit. A schedule management unit divides English words and allocates the divided English words to corresponding dates. A concentrated learning unit performs concentrated learning on individual dates using a method of extracting English words allocated to a selected date, and Korean meanings and images and displaying the English words, the Korean meanings and the images.

### CROSS REFERENCE

This application claims foreign priority under Paris Convention and 35 U.S.C. §119 to Korean Patent Application No. 10-2009-0080326, filed Aug. 28, 2009 with the Korean Intellectual Property Office.

### BACKGROUND OF THE INVENTION

1. Technical Field

The present invention relates, in general, to an English learning apparatus and system, and, more particularly, to an English learning apparatus and system, which can promote the English learning effects of a user using both pictures and user-created word lists to which dual coding theory is applied.

2. Description of the Related Art

The present invention relates to an English learning apparatus and system for supporting the memorization of words using pictures.

Existing English learning apparatuses are configured to learn only the content included in an English learning list stored therein, and thus it is actually difficult for each user to learn the words in his or her English word list that are required to be learned.

Further, the term “English learning” must be accompanied by the memorization of English words. However, existing English learning apparatuses offer limited improvements in the ability to memorize English words because only English words and Korean meanings thereof are represented.

Furthermore, existing English learning apparatuses make it difficult to know each user's weak areas, and cannot provide learning suited to the English level of the user.

### SUMMARY OF THE INVENTION

Accordingly, the present invention has been made keeping in mind the above problems occurring in the prior art, and an object of the present invention is to provide an English learning apparatus and system for supporting the memorization of words using pictures, which can promote the English learning effects of users by using images which are based on dual coding theory and are associated with English words and the Korean meanings thereof.

Another object of the present invention is to provide an English learning apparatus and system for supporting the memorization of words using pictures, which provides a user's desired English word list with English words matched with images and sounds, so that each user can use an actually required English word list, thus promoting English learning effects.

A further object of the present invention is to provide an English learning apparatus and system for supporting the memorization of words using pictures, which manages each user's English learning level to allow the user to perform learning suited to his or her English level, thus enabling English to be learned efficiently.

Yet another object of the present invention is to provide an English learning apparatus and system for supporting the memorization of words using pictures, which promotes each user's ability to memorize English words using the forgetting period (curve) of Hermann Ebbinghaus.

In accordance with an aspect of the present invention to accomplish the above objects, there is provided an English learning system for supporting memorization of words using pictures, comprising a server for providing a user-created word list, and an English learning apparatus for supporting memorization of words using pictures, wherein the server comprises a first server storage unit for storing dictionary data, image data and sound data about English words in association with one another, a second server storage unit for storing a user-created word list, the list including English words, Korean meanings, images and sounds, a matching unit for, when a list of English words and corresponding Korean meanings is received from a user terminal, extracting an image and a sound corresponding to each English word and a corresponding Korean meaning from the first server storage unit, matching the image and sound with the English word and the Korean meaning, generating a user-created word list in which the English word, the Korean meaning, the image and the sound are matched with one another, and storing the user-created word list in the second server storage unit, and a server communication unit for transmitting the user-created word list to the English learning apparatus over a computer network, wherein the English learning apparatus comprises a local storage unit for storing a user-created word list and an English word list, the English word list including dictionary data about each English word, and image data and sound data associated with the English word, a local communication unit for receiving the user-created word list from the second server storage unit via the server communication unit and the computer network, and storing the user-created word list in the local storage unit, a schedule management unit for dividing English words, included in a list selected by an input unit from among the user-created word list and the English word list which are stored in the local storage unit, among individual dates and allocating the divided English words to corresponding dates, and a concentrated learning unit for performing concentrated learning on individual dates using a method of extracting English words allocated to a date selected by the input unit, and Korean meanings and images corresponding to the English words from the local storage unit and of displaying the English words, the Korean meanings and the images, wherein the schedule management unit equally divides English words among individual dates and allocates equal numbers of English words to corresponding dates, or, alternatively, divides English words according to a number of English words input by the input unit among individual dates, allocates the divided English words to the corresponding dates, and repeatedly allocates English words, which have been previously divided and allocated to the individual dates, to the corresponding dates according to a forgetting period of Hermann Ebbinghaus, and wherein the concentrated learning unit sequentially displays each English word, an image, and a Korean meaning at predetermined time intervals, or simultaneously displays two of the English word, the image and the Korean meaning and subsequently displays a remaining one after a predetermined time interval.

Preferably, the English learning apparatus further comprises an intensive learning unit, wherein the intensive learning unit is configured such that when learning mode is switched from concentrated learning to intensive learning by selection of the input unit while concentrated learning is being performed using English words included in the English word list, one or more of a synonym, an antonym, a prefix, a suffix, a part of speech, an example sentence, and interpretation of the example sentence of an English word for which concentrated learning is currently being performed, are extracted from the local storage unit and are additionally displayed.

Preferably, the concentrated learning unit conducts a concentrated learning test after concentrated learning has been completed, the concentrated learning test is configured to randomly extract one English word from English words for which concentrated learning has been performed, present the extracted English word as a question, and present a Korean meaning corresponding to the extracted English word and Korean meanings randomly extracted from the local storage unit as examples, or is configured to randomly extract one English word from English words for which concentrated learning has been performed, present a Korean meaning corresponding to the extracted English word as a question, and present the extracted English word and English words randomly extracted from the local storage unit as examples, and the concentrated learning test is conducted for all English words for which concentrated learning has been performed.

Preferably, the English learning apparatus further comprises a statistical processing unit, the statistical processing unit provides a percentage of correct answers for each date for which concentrated learning has been performed after the test, classifies English words that have been processed as correct answers or incorrect answers into predetermined subjects including one or more of a prefix, a suffix, a part of speech and a number of letters, and displays the classified English words.

Preferably, the local storage unit further stores an English learning level of the user, the English word list of the local storage unit further includes a level based on a degree of difficulty and a degree of importance associated with each English word, the English learning apparatus further comprises a level management unit, the level management unit is configured such that when the English learning level of the user has not yet been set and is not stored in the local storage unit, the level management unit conducts a level test, determines an English learning level of the user according to a resulting test score, and stores the English learning level of the user in the local storage unit, and such that when the English learning level of the user has been previously set and is stored in the local storage unit, the level management unit promotes the English learning level of the user according to a resulting test score from the concentrated learning test, the level test is configured to randomly extract one English word from an English word list selected by the user, present the extracted English word as a question, and present a Korean meaning corresponding to the extracted English word and Korean meanings randomly extracted from the local storage unit as examples, or is configured to randomly extract one English word from the English word list selected by the user, present a Korean meaning corresponding to the extracted English word as a question, and present the extracted English word and English words randomly extracted from the local storage unit as examples, and the schedule management unit divides only English words corresponding to the English learning level of the user, stored in the local storage unit, among individual dates and allocates the divided English words to the corresponding dates.

Preferably, the concentrated learning unit applies a background color to an area in which an English word or a Korean meaning is displayed in a direction from left to right when the English word or the Korean meaning is displayed, wherein speed of application of the background color is proportional to a number of letters.

Preferably, the concentrated learning unit applies a background color to an area in which an English word or a Korean meaning is displayed in a direction from left to right when the English word or the Korean meaning is displayed, wherein speed of application of the background color is proportional to a number of letters, and the background color is implemented as different colors according to a forgetting period of Hermann Ebbinghaus.

Preferably, the English learning apparatus further comprises a pop quiz unit, the pop quiz unit conducts a pop test by randomly extracting one English word from English words for which concentrated learning was previously conducted at arbitrary time while the concentrated learning is being performed, and the pop test is configured to present the extracted English word as a question and present a Korean meaning corresponding to the extracted English word and Korean meanings randomly extracted from the local storage unit as examples, or is configured to present a Korean meaning corresponding to the extracted English word as a question and present the extracted English word and English words randomly extracted from the local storage unit as examples.

Preferably, the pop quiz unit conducts the pop test by randomly extracting one word from English words which are learned on a date corresponding to a forgetting period of Hermann Ebbinghaus, among dates on which the concentrated learning was previously performed.

Preferably, the English learning apparatus further comprises a biorhythm unit, the biorhythm unit calculates physical, emotional and intellectual levels of the user for individual dates according to a date of the user's birth, and the schedule management unit divides English words into different numbers of English words among individual dates depending on the physical, emotional and intellectual levels of the user, which have been calculated for the individual dates, and allocates the different numbers of English words to the corresponding dates.

In accordance with another aspect of the present invention to accomplish the above objects, there is provided an English learning apparatus, comprising a local storage unit for storing a user-created word list and an English word list, the English word list including dictionary data about each English word, and image data and sound data associated with the English word, a local communication unit for receiving the user-created word list from a second server storage unit via a server communication unit and a computer network, and storing the user-created word list in the local storage unit, a schedule management unit for dividing English words, included in a list selected by an input unit from among the user-created word list and the English word list which are stored in the local storage unit, among individual dates and allocating the divided English words to corresponding dates, and a concentrated learning unit for performing concentrated learning on individual dates using a method of extracting English words allocated to a date selected by the input unit, and Korean meanings and images corresponding to the English words from the local storage unit and of displaying the English words, the Korean meanings and the images, wherein the schedule management unit equally divides English words among individual dates and allocates equal numbers of English words to corresponding dates, or, alternatively, divides English words according to a number of English words input by the input unit among individual dates, allocates the divided English words to the corresponding dates, and repeatedly allocates English words, which have been previously divided and allocated to the corresponding dates, to corresponding dates according to a forgetting period of Hermann Ebbinghaus, and wherein the concentrated learning unit sequentially displays each English word, an image, and a Korean meaning at predetermined time intervals, or simultaneously displays two of the English word, the image and the Korean meaning and subsequently displays a remaining one after a predetermined time interval.

### BRIEF DESCRIPTION OF THE DRAWINGS

FIG. 1 is a diagram showing an English learning system for supporting the memorization of words using pictures according to an embodiment of the present invention;

FIG. 2 is a diagram showing the progress of English learning using a user-created word list according to an embodiment of the present invention;

FIG. 3 is a flowchart showing the progress of concentrated learning according to an embodiment of the present invention;

FIG. 4 is a diagram showing the progress of concentrated learning according to an embodiment of the present invention;

FIG. 5 is a diagram showing the progress of intensive learning according to an embodiment of the present invention;

FIG. 6 is a diagram showing a concentrated learning test according to an embodiment of the present invention;

FIG. 7 is a flowchart showing a level test according to an embodiment of the present invention; and

FIG. 8 is a diagram showing a pop test according to an embodiment of the present invention.

### DESCRIPTION OF SPECIFIC EMBODIMENTS

Detailed contents of other embodiments are included in detailed descriptions and drawings.

The above and other objects, features and advantages of the present invention will be more clearly understood from the following embodiments described below in detail with reference to the accompanying drawings. However, the present invention is not limited to the embodiments which will be described below, and can be implemented in various forms. Those embodiments are merely intended to make the disclosure of the present invention complete and are provided to completely notify those skilled in the art of the scope of the present invention, and the present invention is defined by the scope of the accompanying claims. The same reference numerals are used throughout the different drawings to designate the same or similar components.

Hereinafter, embodiments of an English learning apparatus and system for supporting the memorization of words using pictures according to the present invention will be described in detail with reference to the attached drawings.

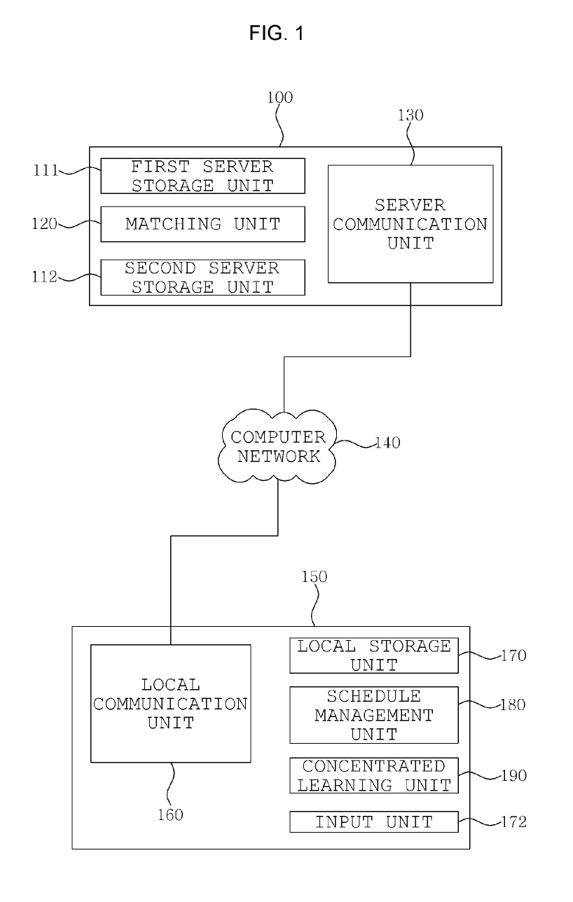

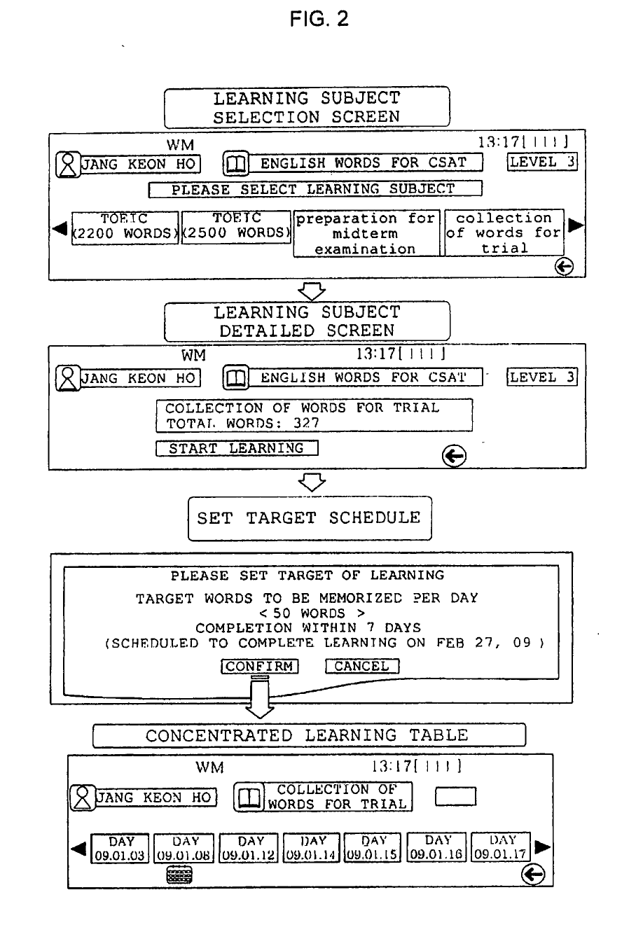

FIG. 1 is a diagram showing an English learning system for supporting the memorization of words using pictures according to an embodiment of the present invention. FIG. 2 is a diagram showing the progress of English learning using a user-created word list according to an embodiment of the present invention.

The English learning system for supporting the memorization of words using pictures according to the embodiment of the present invention includes a server 100 for providing user-created words, and an English learning apparatus 150 for supporting the memorization of words using pictures.

The server 100 for providing the user-created words includes a first server storage unit 111, a second server storage unit 112, a matching unit 120, and a server communication unit 130. The first server storage unit 111 stores dictionary data, image data and sound data about English words in association with one another. The second server storage unit 112 stores a user-created word list including English words, Korean meanings, images, and sounds. When a list of English words and their corresponding Korean meanings is received from a user terminal, the matching unit 120 extracts images and sounds corresponding to the English words and the Korean meanings from the first server storage unit 111, matches the images and sounds with the English words and the Korean meanings, generates a user-created word list in which the English words and the Korean meanings match the images and the sounds, and stores the user-created word list in the second server storage unit 112. The server communication unit 130 transmits the user-created word list to the English learning apparatus 150 over a computer network.

The English learning apparatus 150 for supporting the memorization of words using pictures includes a local storage unit 170, a local communication unit 160, a schedule management unit 180, and a concentrated learning unit 190. The local storage unit 170 stores the user-created word list and the English word list, wherein the English word list includes dictionary data about English words, and image data and sound data associated with the English words. The local communication unit 160 receives the user-created word list from the second server storage unit 112 via the server communication unit 130 and the computer network 140, and stores the user-created word list in the local storage unit 170. The schedule management unit 180 divides English words, included in the list selected by an input unit 172 from among the user-created word list and the English word list which are stored in the local storage unit 170, among individual dates and allocates the divided English words to the corresponding dates. The concentrated learning unit 190 performs concentrated learning on individual dates by using a method of extracting English words, allocated to a date selected by the input unit 172 and Korean meanings and images corresponding to the English words, from the local storage unit 170, and displaying the English words, Korean meanings and images.

Dictionary data about English words stored in the first server storage unit 111 denotes information about words recorded in an English dictionary, and includes English words, Korean meanings thereof, parts of speech, phonetic symbols, synonyms, antonyms, the prefix, the suffix, example sentences thereof, and the interpretation of the example sentences.

Further, the image data stored in the first server storage unit 111 includes images that can be associated with English words or Korean meanings so as to improve the ability to memorize English words. Such images may be pictures, photographs or moving images.

Furthermore, the sound data stored in the first server storage unit 111 denotes data in which voice is stored so that the user can listen to the pronunciation of English words using the English learning apparatus.

When a list of English words and their corresponding Korean meanings is received from the user terminal, the matching unit 120 extracts images and sounds corresponding to the individual English words and Korean meanings from the first server storage unit 111, matches the images and sounds with the English words and Korean meanings, generates a user-created word list in which the English words and their corresponding Korean meanings are matched with the images and sounds, and stores the user-created word list in the second server storage unit 112.

Since the first server storage unit 111 stores image data and sound data in association with dictionary data about English words, the matching unit 120 extracts images and sounds, associated with English words included in the list received from the user terminal, from the first server storage unit 111, and matches the extracted images and sounds with the English words.

Further, when there are multiple images associated with one English word, an image associated with the Korean meaning of the English word is extracted from the multiple images, and the extracted image is matched with the English word.

Furthermore, it is also possible that in case the user personally enters a list into a homepage, he or she may select one from among multiple images associated with a given English word when there are multiples images associated with that English word.

Preferably, the user terminal may be a Personal Computer (PC), but may include various types of terminals such as a mobile communication terminal, a Personal Digital Assistant (PDA), a learning-only portable information device, an electronic dictionary, an e-book terminal, a portable language audio device, a portable terminal enabling a Wireless Local Area Network (WLAN), for example, Mintpad, and the English learning apparatus, in addition to the PC.

The user may create a list composed of English words and their corresponding Korean meanings, and upload the list onto the server. Alternatively, the user may personally enter the list via the homepage of a company that provides the English learning system.

The local communication unit 130 may be connected to the PC through terminals, but may include a WLAN function such as a Wireless Fidelity (Wi-Fi) function.

Therefore, the user may download user-created English word lists, which have been created by other users and uploaded onto the server, to the English learning apparatus 150 for supporting the memorization of words using pictures, and may receive those lists from the English learning apparatuses of other users via the WLAN function.

Furthermore, the user can learn English words by downloading user-created word lists in which images and sounds corresponding to English words and their Korean meanings are matched with one another, thus improving the efficiency of learning. Further, there is an advantage in that the time and effort involved with a user personally creating the desired English word list can be reduced, thus allowing the user to efficiently learn English.

The local storage unit 170 of the English learning apparatus 150 for supporting the memorization of words using pictures includes the functions of downloading and storing previously stored English word lists and user-created word lists stored in the second server storage unit 112.

The English word lists have been previously included for the English learning of the user, and include lists stored for respective subjects, for example, 500 words for an elementary school course, 1500 words for a junior high school course, 2300 words for TOEIC, and 500 words for a basic essential course.

Further, the user-created word list has a title made up by the user, and may be indicated by, for example, preparation for midterm examination, collection of words for trial examination, etc.

The schedule management unit 180 of the English learning apparatus 150 for supporting the memorization of words using pictures divides English words, included in a list selected by the input unit from among the user-created word lists and the English word lists which are stored in the local storage unit 170, among individual dates, and allocates the divided English words to the corresponding dates, thus allowing the user to proceed with learning in accordance with individual dates.

Further, the schedule management unit 180 displays learning progress in the form of a calendar or a table so that the user can easily manage learning progress and can easily check the state of the progress being made.

In a preferred embodiment, when the schedule management unit 180 displays the learning progress in the form of a table, a test score is simply indicated (as ‘excellent’, ‘good’, ‘bad’, etc.) with respect to the date of learning, and the date of today's learning is indicated by a red frame or the like.

It is preferable that English words allocated to one date be learned per day so as to let the user know the scheduled date of the completion of learning; however, it is possible for the user to learn English words corresponding to a plurality of dates when the user delays learning and did not learn English words corresponding to previous dates.

Further, in order to impart the user with a sense of accomplishment, it is possible to allow the user to perform learning corresponding to the next date only after the English words allocated to one date have been learned.

As another embodiment, when the schedule management unit 180 displays learning progress in the form of a calendar, how steadily the user has learned can be entirely and visually monitored by marking a seal or the like on the date on which the learning was done. The completion of learning can be indicated by marking the date, on which learning was completed and a predetermined score or greater is obtained on the test, as a red circle or the like. Further, when the user performs only learning and does not take a test, or when the user does not get a predetermined score or greater, a blinking circle or the like is presented, thus indicating that learning on a relevant date is incomplete. When the user passes the test by getting a predetermined score or greater one or few days later, the blinking circle can be replaced with a complete circle or the like. Further, a visual effect may be provided in such a way as to indicate the scheduled date for the completion of learning as a stellar shape or the like on the calendar.

After English words have been divided by and allocated to individual dates by the schedule management unit 180, and learning progress is displayed in the form of a calendar or a table, the user may select the date of learning by manipulating the input unit.

The concentrated learning unit 190 performs concentrated learning for individual dates using a method of extracting English words allocated to the date selected by the user, Korean meanings and images corresponding to the English words from the local storage unit 170 and displaying the English words, the Korean meanings and the images.

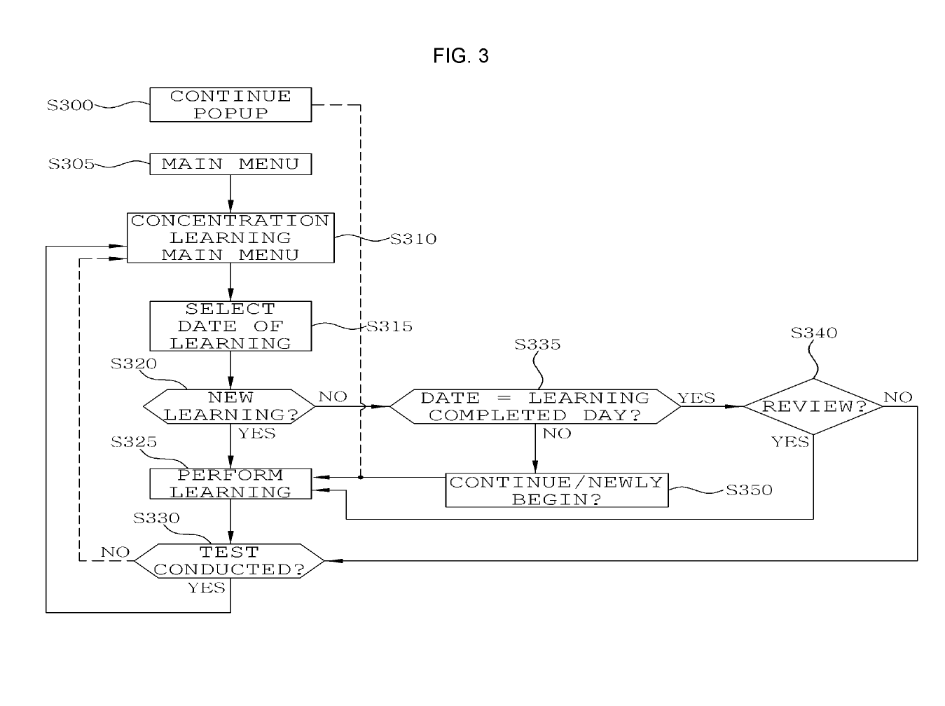

FIG. 3 is a flowchart showing the progress of concentrated learning according to an embodiment of the present invention.

Referring to the embodiment of the present invention with reference to FIG. 3, a popup window enabling concentrated learning that had previously been performed to continue is displayed at step S300. When the user continues to perform concentrated learning, the previous concentrated learning is continuously performed at step S325.

When the user does not continue to perform concentrated learning, a main menu is selected at step S310. When a main screen for concentrated learning is displayed at step S310, the user selects the date of learning at step S315. When the selected date corresponds to new learning at step S320, learning is performed from the beginning, whereas when the selected date does not correspond to new learning at step S320, whether the selected date is the day on which learning has been completed is determined at step S335. When learning has not been completed, the user may continue to perform learning or newly begin the learning at step S350. When learning has been completed, the user is prompted to select whether to conduct a review at step S340. When the user selects a review, concentrated learning is performed again. When the user does not select a review, the user is asked to apply for a test when the learning progress is completed at step S330. When applying for a test, the user takes the test that covers the English words that had been learned. When the user does not apply for a test, the current screen returns to the main screen for concentrated learning.

The main screen for concentrated learning includes displaying learning progress in the form of a calendar or a table using the schedule management unit 180. The input unit 172 is a user interface device for performing learning, function selection, setting input, etc., and includes, for example, a keypad, a keyboard, a mouse input unit, a touch screen, etc.

The concentrated learning unit 190 performs concentrated learning using a method of displaying English words, Korean meanings, and images which are stored in the local storage unit. Images that can easily associated with English words or corresponding Korean meanings are displayed, so that learning is performed, thus improving the effects of memorizing English words.

For example, in order to learn the word “laden” which means “carrying a load or burden”, an image indicating a person carrying a load or a burden and associated with the Korean meaning of the word is displayed.

This is based on dual coding theory, which means that a human being has two types of cognitive coding functions, and thus visual information is spatially coded and verbal information is systematically coded.

When information is learned in visual and verbal forms, respective pieces of information are stored in separate cognitive systems, and information memorized using both a word and a picture is reproduced better than information memorized using either a word or a picture.

That is, according to dual coding theory, since the reproduction of information is to find certain information from memory, information having two information processing locations is remembered better than information having only one information processing location.

Therefore, when a word, a picture and a sound are presented based on a principle in which they are spatially associated with one another, these are processed in a manner different from the case where they are systematically ordered. That is, such a theory indicates that it will be more effective to present verbal information and visual information together than to separately present verbal information and visual information.

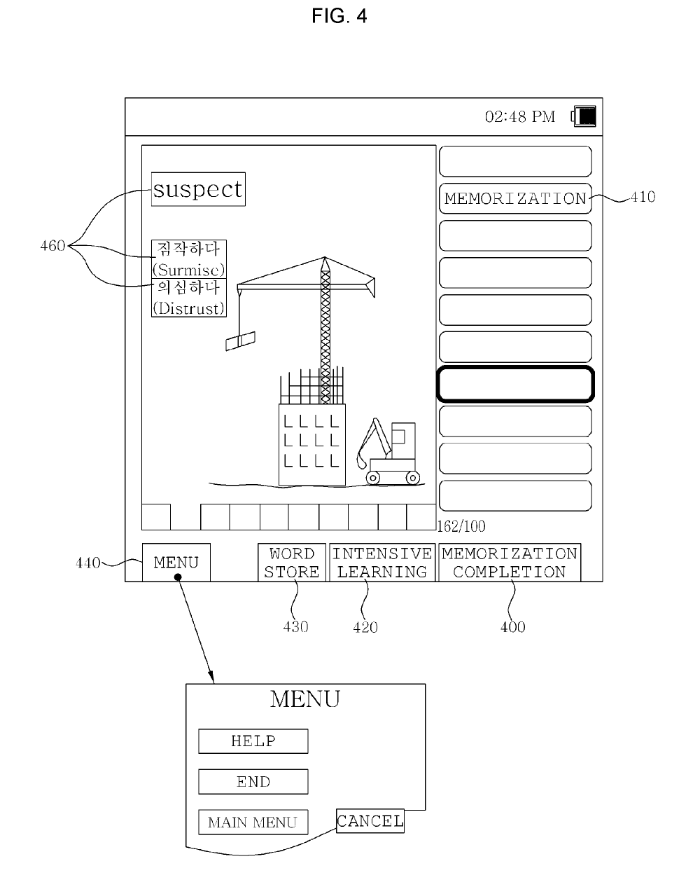

FIG. 4 is a diagram showing the progress of concentrated learning according to an embodiment of the present invention. A preferred embodiment will be described with reference to FIG. 4.

A concentrated learning screen according to the present invention is configured such that 10 words are included in one set, and a design required to indicate individual words is represented by three types, that is, ‘the word currently being learned’, ‘the word not currently being learned’, and ‘the checked (hidden) word’. Further, the screen is mainly divided into a space for ‘English word’, a space for ‘image’ and a space for ‘Korean meaning’. Under an image, 10 sets are displayed, a set currently being learned is indicated by blank, and a set that has been learned is displayed in the color of sky blue. On the right side of the image, when a memorization completion button 400 is pressed, memorization 410 is displayed. When a word store button 430 is pressed, words are stored in ‘My own word glossary’. When an intensive learning button 420 is pressed, the current screen is switched to an intensive learning screen. When the memorization completion button is pressed, the current word is excluded from the second round of the two-step learning. When a menu button 440 is pressed, the user may move to ‘help’, ‘end’ or ‘main menu’.

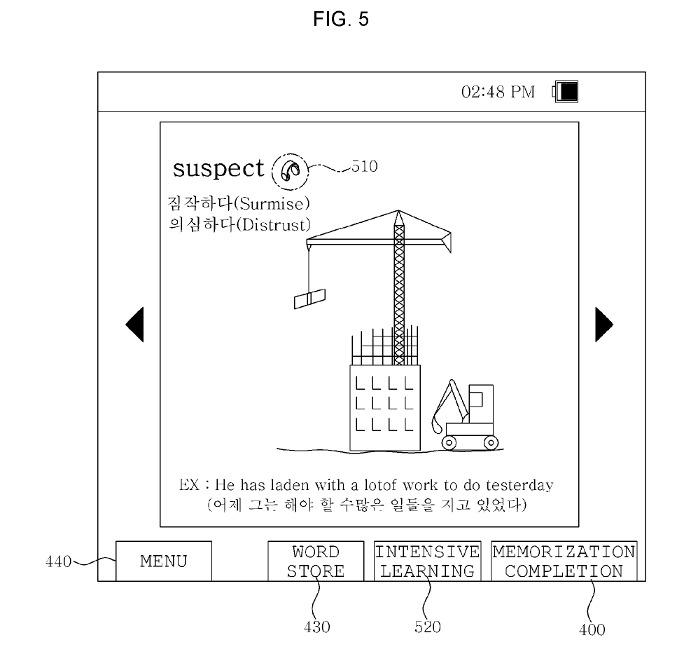

FIG. 5 is a diagram showing the progress of intensive learning according to an embodiment of the present invention.

The English learning apparatus 150 for supporting the memorization of words using pictures further includes an intensive learning unit. The intensive learning unit is configured such that when the learning mode is switched from concentrated learning to intensive learning by the selection of the input unit 172 while concentrated learning is being performed using English words included in an English word list, one or more of a synonym, an antonym, a prefix, a suffix, a part of speech, an example sentence, and the interpretation of the example sentence of an English word, for which concentrated learning is currently being performed, are extracted from the local storage unit 170, and are additionally displayed.

A preferred embodiment will be described below with reference to FIG. 5. Intensive learning may include a word, an image, a meaning, a synonym, an antonym, an example sentence, and the interpretation of the example sentence. When left and right movement buttons are pressed while intensive learning is being performed, the current screen moves to a concentrated learning screen for the previous or next word.

Further, it is possible to repeatedly listen to the pronunciation of a given word by inserting and pressing a pronunciation button 510, and to allow the entire content to be viewed while dragging an icon on the screen using a touch pen when learning content is long. The menu button 440, word store button 430, and memorization completion button 400 are identical to those of concentrated learning. Even if any location on the main screen for intensive learning is touched, learning mode can return to concentrated learning; however, when the intensive learning button 520 is pressed, the screen is configured to move to concentrated learning after intensive learning has been completed.

This structure provides more intensive learning for English words, and allows the user to satisfy his or her curiosity for English words, thus promoting English learning effects.

The concentrated learning unit 190 conducts a concentrated learning test after concentrated learning has been terminated. Such a concentrated learning test is characterized by randomly extracting one English word from English words for which concentrated learning has been completed, presenting the extracted English word as a question, and presenting a Korean meaning corresponding to the extracted English word and other Korean meanings randomly extracted from the local storage unit as examples. Alternatively, the concentrated learning test is characterized by randomly extracting one English word from English words for which concentrated learning has been completed, presenting a Korean meaning corresponding to the extracted English word as a question, and presenting the extracted English word and other English words randomly extracted from the local storage unit as examples, wherein the test is conducted on all English words for which concentrated learning has been completed.

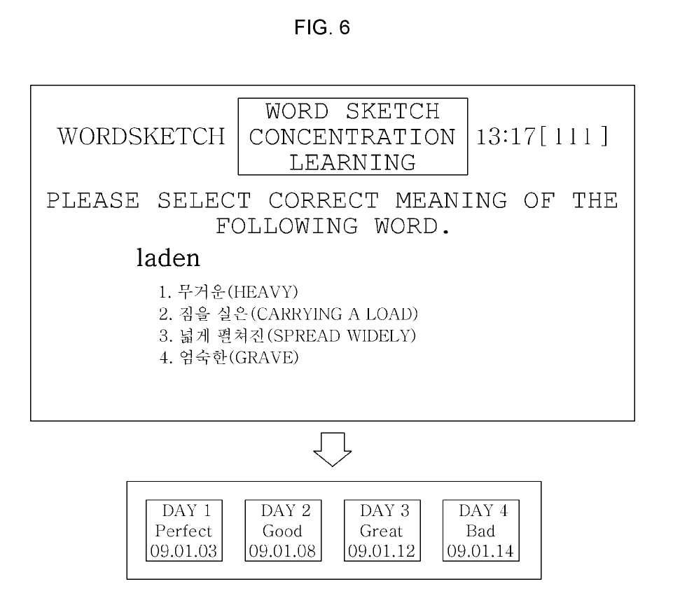

FIG. 6 is a diagram showing a concentrated learning test according to an embodiment of the present invention.

A preferred embodiment will be described below with reference to FIG. 6. The concentrated learning unit 190 provides test items on respective dates after concentrated learning for individual dates has been terminated.

The target of testing is all the English words for the day on which concentrated learning was performed, and the test is configured to basically be conducted once. The number of repetitions can be changed by the user, or the provider of the learning apparatus and system.

The type of question may include a question about an English word and examples of Korean meanings, as shown in FIG. 6, and may also include a question about a Korean meaning and examples of English words.

Phrases based on the results of the test are displayed on the main screen for concentrated learning. When a user does not pass the test, the case where his or her score is less than 60 can be displayed as ‘POOR’, and the case where the score is equal to or greater than 60 and is less than 80 can be displayed as ‘BAD’. Further, when the user passes the test, the case where his or her score is equal to or greater than 80 and is less than 90 can be displayed as ‘GOOD’, the case where the score is equal to or greater than 90 and is less than 100 can be displayed as ‘GREAT’, and the case where the score is 100 can be displayed as ‘PERFECT’.

Words that were processed as incorrect answers in the test are automatically updated in an ‘incorrect answer note’ menu in the ‘word storehouse’.

The test can be conducted from the time point at which learning on a relevant date was completed, and can also be separately conducted not immediately but later. When the test is delayed, ‘NO GRADE’ is displayed on the main screen for concentrated learning.

However, in order for a level management unit to level up a user, the user must take all tests for the corresponding levels, and must get at least a predetermined score or greater on all of the tests; otherwise popup information indicating that leveling up is impossible is displayed on the screen.

The English learning apparatus 150 for supporting the memorization of words using pictures further includes a statistical processing unit. The statistical processing unit is characterized in that, after the tests, it provides a percentage of correct answers for each test date on which concentrated learning was performed, and it also classifies the English words that have been processed as correct answers or incorrect answers into predetermined subjects including one or more of a prefix, a suffix, a part of speech and the number of letters, and displays the results of this classification.

That is, in a predetermined embodiment, when the user takes a concentrated learning test after completing concentrated learning, the statistical processing unit presents the test results of the user for each date, and displays the test results in the form of percentages of correct answers. This is preferably displayed in the form of a graph, but may be displayed in the form of a diagram or grades such as A+, in addition to the graph.

Further, the statistical processing unit classifies words that have been processed as correct answers or incorrect answers into predetermined subjects such as a prefix, a suffix, a part of speech, or the number of letters, and displays the results of this classification. For example, in the case of parts of speech, when the user gets five correct answers out of seven questions for a noun, and gets one correct answer out of three questions for a verb, English words used in the test are classified into a noun and a verb with reference to dictionary data stored in the local storage unit 170. A percentage of correct answers for a noun, that is, 71.4% and a percentage of correct answers for a verb, that is, 33.3% are displayed. Further, a percentage of incorrect answers and not the percentage of correct answers may be displayed.

This presents statistics for weak areas of the user to induce the user to intensively focus learning on the weak areas and to be aware of his or her weak area, thus enabling English to be learned more efficiently.

The local storage unit 170 is characterized by further storing the English learning level of the user. The English word list stored in the local storage unit 170 further includes levels based on the degree of difficulty and the degree of importance associated with each English word. The English learning apparatus 150 for supporting the memorization of words using pictures further includes a level management unit.

The level management unit is characterized in that, when the English learning level of the user has not yet been set and was not stored in the local storage unit 170, the level management unit conducts a level test and determines the English learning level of the user according to the test score, and in that, when the English learning level of the user is preset and stored in the local storage unit 170, the level management unit promotes the English learning level on the basis of the score from the concentrated learning test.

The level test is characterized by randomly extracting one English word from the English word list selected by the user, presenting the extracted word as a question and presenting a Korean meaning corresponding to the English word and Korean meanings randomly extracted from the local storage unit 170 as examples, or characterized by randomly extracting one English word from the English word list selected by the user, presenting a Korean meaning corresponding to the extracted English word as a question, and presenting the extracted English word and English words randomly extracted from the local storage unit as examples.

The schedule management unit 180 is characterized by dividing only English words, corresponding to the English learning level of the user stored in the local storage unit 170, among individual dates and allocating the divided English words to the corresponding dates.

In the list of English words stored in the local storage unit 170, levels indicating the degree of importance and the degree of difficulty of each English word are further stored.

The level of each English word is determined on the basis of the number of times that the word appears in a textbook, a self-teaching book and a related collection of problems, the frequency of the word on tests, opinions of English educators and students, etc. Individual grades indicating the level are preferably represented by numbers, and may be represented by other grades such as A, B and C.

The level management unit conducts a level test when the user has not taken a level test and the user's English learning level has not yet been set.

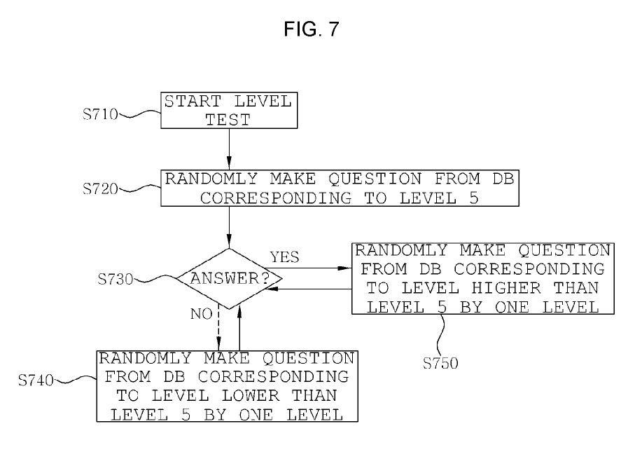

FIG. 7 is a flowchart showing a level test according to an embodiment of the present invention.

A preferred embodiment will be described below with reference to FIG. 7. A level test begins at step S710, and an initial question is randomly made from English words corresponding to level 5 at step S720. In relation to this, when the user enters an answer, whether the answer is correct or incorrect is determined at step S730. When the user gets the correct answer to the question, a next question is made randomly from English words corresponding to a level higher than level 5 by one level at step S750. When the user does not get the correct answer, a next question is randomly made from English words corresponding to a level lower than level 5 by one level at step S740.

The range of the level test basically covers each subject to be learned. A word (meaning) presented as a question and words (meanings) presented as answers preferably have the same part of speech when questions are made. This may be realized using dictionary data about English words stored in the local storage unit 170.

The type of question may include a question about an English word and examples of Korean meanings, and may also include a question about a Korean meaning and examples of English words.

The method of determining a level is performed such that after a test has been conducted on a total of 30 questions, the levels of the words processed as correct answers are added up to obtain a summation value, the summation value is divided by the number of questions corresponding to correct answers to obtain a certain value, decimals are omitted from the certain value to obtain a resulting value, and 1 is subtracted from the resulting value, thus obtaining the final level. The reason for subtracting 1 is that the test is conducted using the levels, and thus the probability of unknown words existing in words for which the test is not conducted is minimized.

Further, the level management unit presents the level value, obtained by the learner, to the learner, and thereafter displays the test results of the learner in the form of a graph, thus allowing the user to think of the test to be an objective test.

Furthermore, the schedule management unit 180 stores the English learning level of the user determined by the level test in the local storage unit 170, divides English words corresponding to the English learning level among individual dates and allocates the divided English words to the corresponding dates so that the user can perform concentrated learning.

Further, the level management unit promotes the English learning level of the user when the user completes all learning content on the dates to which English words corresponding to the English learning level were allocated, takes concentrated learning tests presented after concentrated learning on the dates has been completed, and gets results above a predetermined score in the tests.

When the conditions are not fulfilled, the level management unit displays popup information indicating that learning for a relevant level has been completed when the user completes learning currently being performed for a relevant date and returns to the main screen for concentrated learning. However, the level management unit also notifies the user that he or she cannot be promoted to the next level because the conditions have not been fulfilled.

When the conditions are fulfilled, the level management unit displays popup information indicating that leveling up has been completed as in a left image. After leveling up has been performed, learning may continue.

The displaying of leveling up is implemented to display the user's level as a level promoted by one level even after the user passes all the word tests corresponding to the relevant level. This makes the user learn English words suited to his or her English level, thus improving learning effects and shortening the learning time.

The schedule management unit 180 is characterized by equally dividing English words among individual dates and allocating the divided English words to the corresponding dates, or characterized by dividing English words according to the number of English words input by the input unit and allocating the divided English words to individual dates. Further, the schedule management unit 180 is characterized by dividing English words among individual dates and allocating the divided English words to the corresponding dates so that the user can repeatedly learn English words according to the forgetting period (curve) of Hermann Ebbinghaus.

The schedule management unit 180 divides English words corresponding to the list selected by the user from the local storage unit 170 among individual dates, and allocates the divided English words to the corresponding dates. In this case, such division and allocation may be performed such that English words are automatically equally divided and allocated to the individual dates by the schedule management unit 180. Further, English words may be divided by the number of English words personally designated by the user and may then be allocated.

This results in the effects of learning English being more flexible and efficient because English words are equally divided by the schedule management unit 180 to allow the user to easily follow one's progress with the scheduled learning and to personally designate the number of English words to be learned according to the environment of the user.

Further, the schedule management unit 180 is characterized by repeatedly allocating English words, which have been divided and allocated to individual dates, to dates corresponding to the forgetting period of Hermann Ebbinghaus.

Here, the term “the forgetting period of Hermann Ebbinghaus” means that the memory of a human being rapidly decreases immediately after learning, a human being forgets 60% of memorized information after one hour has elapsed, forgets 76% of the memorized information after one day has elapsed, and forgets 90% of the memorized information after one month has elapsed, so that when a review is performed before such forgetting occurs, the acquired information can be memorized for a much longer period of time. In this case, the important fact is that before forgetting occurs, a review must be performed. Generally, since forgetting occurs after about 10 minutes, learned content is retained for one day if it is reviewed only for five minutes, and is retained for one week if the learned content is reviewed again only for five minutes at the corresponding time on the next day. Further, the learned content is retained for one month if it is reviewed again after one week. Further, if the learned content is reviewed again after another one month, the memory of the learned content is not forgotten for about sixth months. From that point, the learned content is retained in long-term memory, so that the learned content can be continuously retained only if it is learned once every six months or once every year. Therefore, when the forgetting period of Hermann Ebbinghaus is applied to the memorization of words, as described above, the efficiency of word learning can be maximized.

Therefore, referring to a preferred embodiment of the present invention, the schedule management unit 180 allocates English words, which have been allocated to the first day, to the second day which is the day after one day has elapsed, allocates the English words to the eighth day which is the day after one week has elapsed, and allocates the English words to the day after one month has elapsed so that the English words can be repeatedly learned. This allocation is implemented in such a way that the repeatedly allocated English words may overlap with English words that have been already allocated to the second day, or may not overlap with them.

In the preferred embodiment, the period of Ebbinghaus has been set as one day, one week, and one month, but may be changed by the user or a production company.

The concentrated learning unit 190 is characterized by sequentially displaying each English word, an image, and a Korean meaning at predetermined time intervals, or by simultaneously displaying two of the English word, the image and the Korean meaning and subsequently displaying the remaining one after a predetermined time interval.

Referring to FIG. 4, concentrated learning is performed by displaying an English word, a Korean meaning, and an image, which are displayed, not simultaneously, but sequentially.

This induces the user to think for himself or herself, thus improving the effects of learning English words.

Referring to a preferred embodiment, when the word ‘laden’ is presented as an English word, only the English word is displayed for two seconds, an image is subsequently displayed together with the English word for two seconds, and finally a Korean meaning is displayed together with the English word and the image for one second, in a first repetition. In a second repetition, an English word and an image are simultaneously displayed for two seconds, and thereafter a Korean meaning is displayed together with the English word and the image for one second. In a third repetition, only an English word and a Korean meaning are displayed. This helps the learner associate the English word and the Korean meaning with an image by excluding the image, thus strengthening the relationship between the image and the meaning of the word.

Further, the concentrated learning unit 190 is characterized by applying a background color 460 to an area in which an English word or a Korean meaning is displayed, in a direction from left to right when the English word or the Korean meaning is displayed, wherein the speed of application of the background color is proportional to the number of letters.

FIG. 4 is a diagram showing concentrated learning according to an embodiment of the present invention. A predetermined embodiment will be described below with reference to FIG. 4. During concentrated learning, the concentrated learning unit 190 applies a background color to the English word ‘suspect’. Here, the speed of the application of the background color is proportional to the number of letters. In the case of the word ‘extrabudgetary’, the number of letters is twice that of the word ‘suspect’, and thus the speed of the application increases twice. Consequently, the time required to color an English word is identical regardless of the number of letters.

The reason for this is that the time required to apply a background color is uniform, so that the time required to memorize an English word is also uniform, and the user's eyes are focused on the English word, thus improving the effects of memorization.

This is equally applied to the Korean meaning.

Further, the concentrated learning unit 190 is characterized by applying a background color to an area in which an English word or a Korean meaning is displayed, in a direction from left to right when the English word or the Korean meaning is displayed, wherein the speed of application of the background color is proportional to the number of letters and the background color may be different colors according to the forgetting period of Hermann Ebbinghaus.

In a preferred embodiment related to the forgetting period of Hermann Ebbinghaus, the period is set as one day, one week, and one month. When this period is applied, the background color of the area in which the English word or the Korean meaning is displayed may be made in different colors when one day, one week and one month respectively have elapsed. The colors may be displayed darkly or brightly.

This results in the effect of the user easily being notified of the elapsed learning time by changing the colors when the user learns English words for a long period starting from the first day of learning.

The English learning apparatus 150 for supporting the memorization of words using pictures further includes a pop quiz unit. The pop quiz unit conducts a pop quiz (pop test) by randomly extracting one word from the English words for which concentrated learning was previously performed at an arbitrary time while concentrated learning is being performed.

The pop test is characterized by presenting the extracted English word as a question and presenting the Korean meaning corresponding to the English word and Korean meanings randomly extracted from the local storage unit 170 as examples, or is characterized by presenting the Korean meaning corresponding to the extracted English word as a question and presenting the extracted English word and English words randomly extracted from the local storage unit 170 as examples.

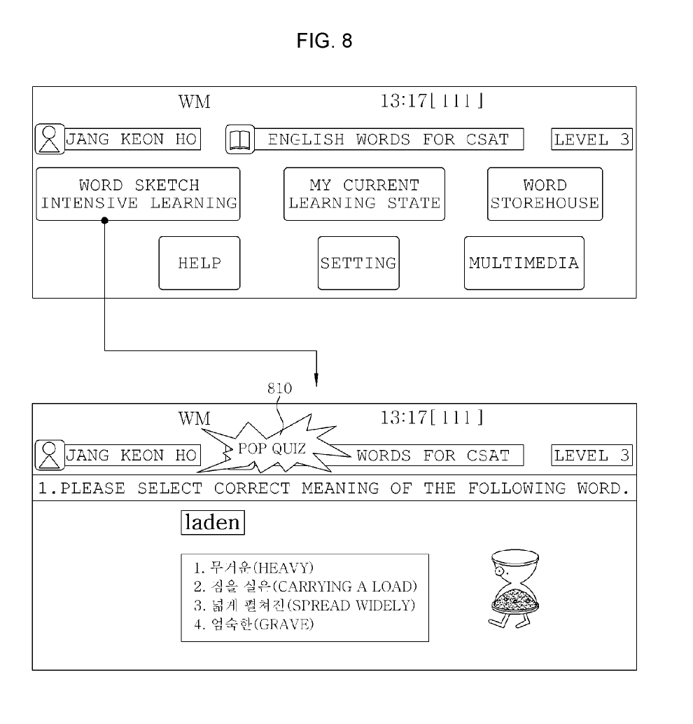

FIG. 8 is a diagram showing a pop test according to an embodiment of the present invention.

A predetermined embodiment will be described below with reference to FIG. 8. While the user is performing concentrated learning, the word ‘laden’ randomly extracted from English words for which concentrated learning was previously performed is suddenly presented as a question, and ‘ [symbol] ’ indicating the Korean meaning of ‘laden’ and Korean meanings randomly extracted from the local storage unit 170 are provided as examples.

Such a pop test (pop quiz) is presented at an arbitrary time while concentrated learning is being performed in such a way that the pop test can be provided simultaneously with the start of concentrated learning, or can be provided in the middle of concentrated learning. Further, the type of question may be implemented to include a question about an English word and examples of Korean meanings, or alternatively include a question about a Korean meaning and examples of English words.

Further, the case where the pop test is processed as a correct answer and the case where it is processed as an incorrect answer are separated, and sounds and comments can be provided differently for the two cases.

In the case of sounds, when a correct answer is given, a sound indicating congratulations such as ‘Wow˜(hand clapping sound)’ is provided, whereas when an incorrect answer is given, a type of sound such as ‘Gosh˜pop’ is provided.

In the case of comments, phrases for motivation, learning tips, etc. can be provided together with information about words regardless of the answer being correct or incorrect, and the time when the user actually learned a relevant word can be shown to the user.

This allows the user to take a test for words that were previously learned at an arbitrary time while concentrated learning is being performed, so that the user is induced to review words without feeling tedious, thus improving the effects of memorization.

The pop quiz unit is characterized by randomly extracting one word from English words that have been learned on some dates, corresponding to the forgetting period of Hermann Ebbinghaus, among those dates on which concentrated learning was previously performed, and conducting a pop test.

In a predetermined embodiment of the forgetting period of Hermann Ebbinghaus, periods corresponding to one day, one week, and one month are set. When these periods are applied, if it is assumed that an eighth day is the date of concentrated learning regardless of the actual dates, a pop test is conducted by randomly extracting one word from the English words for which concentrated learning was performed on the first day and the seventh day of the learning dates.

This results in the effect of further improving memorization because a learning method based on the forgetting period of Hermann Ebbinghaus is applied to the effects of the pop test, that is, the induction of the user to review the previous words without feeling tedious.

The English learning apparatus 150 for supporting the memorization of words using pictures further includes a biorhythm unit. The biorhythm unit calculates physical, emotional and intellectual levels for respective dates on the basis of the date of the user's birth. The schedule management unit divides English words into different numbers of English words among individual dates and allocates different numbers of English words to the corresponding dates depending on the physical, emotional and intellectual levels calculated for the individual dates.

The biorhythm unit calculates the physical, emotional and intellectual levels of the user for individual dates on the basis of the following function,

F1(date of user's birth)=(P, S, I)

where P is a physical value, S is an emotional level, and I is an intellectual level.

The schedule management unit 180 divides English words to be learned by the user into different numbers of English words among individual dates and allocates the different numbers of English words to the corresponding dates depending on the physical, emotional and intellectual levels calculated by the biorhythm unit on the basis of the following function,

F2(P, S, I)=K

where K is the number of English words allocated to each date.

When the physical condition, emotional condition and intellectual condition indicate high levels, a large number of words can be learned, and thus the function F2 is preferably set so that K is a value proportional to each of P, S and I values.

Further, the schedule management unit 180 may allocate English words having a high percentage of correct answers to dates on which physical, emotional and intellectual levels are low, and may allocate English words having a low percentage of correct answers to dates on which physical, emotional and intellectual levels are high, with reference to the percentages of correct answers obtained by the statistical processing unit.

As described above, the present invention can provide an English learning apparatus and system for supporting the memorization of words using pictures, which can promote the English learning effects of users by using images which are based on dual coding theory and are associated with English words and the Korean meanings thereof.

Further, the present invention can provide an English learning apparatus and system for supporting the memorization of words using pictures, which provides a user's desired English word list with English words matched with images and sounds, so that each user can use an actually required English word list, thus promoting English learning effects.

Furthermore, the present invention can provide an English learning apparatus and system for supporting the memorization of words using pictures, which manages each user's English learning level to allow the user to perform learning suited to his or her English level, thus enabling English to be learned efficiently.

In addition, the present invention can provide an English learning apparatus and system for supporting the memorization of words using pictures, which promotes each user's ability to memorize English words using the forgetting period of Hermann Ebbinghaus.

Those skilled in the art will appreciate that the present invention can be implemented in other detailed forms without changing the technical scope or essential features of the invention. Therefore, the embodiments should be understood to be exemplary rather than restrictive in all aspects. The scope of the present invention is defined by the accompanying claims rather than the detailed description. The meanings and scopes of the claims and all changes or modifications derived from equivalents thereof should be interpreted as being included in the scope of the present invention.

What is claimed is:

1. An English learning system for supporting memorization of words using pictures, comprising:
a server for providing a user-created word list; and
an English learning apparatus for supporting memorization of words using pictures, wherein the server comprises:
a first server storage unit for storing dictionary data, image data and sound data about English words in association with one another;
a second server storage unit for storing a user-created word list, the list including English words, Korean meanings, images and sounds;
a matching unit for, when a list of English words and corresponding Korean meanings is received from a user terminal, extracting an image and a sound corresponding to each English word and a corresponding Korean meaning from the first server storage unit, matching the image and sound with the English word and the Korean meaning, generating a user-created word list in which the English word, the Korean meaning, the image and the sound are matched with one another, and storing the user-created word list in the second server storage unit; and
a server communication unit for transmitting the user-created word list to the English learning apparatus over a computer network, wherein the English learning apparatus comprises:
a local storage unit for storing a user-created word list and an English word list, the English word list including dictionary data about each English word, and image data and sound data associated with the English word;
a local communication unit for receiving the user-created word list from the second server storage unit via the server communication unit and the computer network, and storing the user-created word list in the local storage unit;
a schedule management unit for dividing English words, included in a list selected by an input unit from among the user-created word list and the English word list which are stored in the local storage unit, among individual dates and allocating the divided English words to corresponding dates; and
a concentrated learning unit for performing concentrated learning on individual dates using a method of extracting English words allocated to a date selected by the input unit, and Korean meanings and images corresponding to the English words from the local storage unit and of displaying the English words, the Korean meanings and the images, wherein the schedule management unit equally divides English words among individual dates and allocates equal numbers of English words to corresponding dates, or, alternatively, divides English words according to a number of English words input by the input unit among individual dates, allocates the divided English words to the corresponding dates, and repeatedly allocates English words, which have been previously divided and allocated to the individual dates, to the corresponding dates according to a forgetting period of Hermann Ebbinghaus, and wherein the concentrated learning unit sequentially displays each English word, an image, and a Korean meaning at predetermined time intervals, or simultaneously displays two of the English word, the image and the Korean meaning and subsequently displays a remaining one after a predetermined time interval.

2. The English learning system according to claim 1, wherein the English learning apparatus further comprises an intensive learning unit, wherein the intensive learning unit is configured such that when learning mode is switched from concentrated learning to intensive learning by selection of the input unit while concentrated learning is being performed using English words included in the English word list, one or more of a synonym, an antonym, a prefix, a suffix, a part of speech, an example sentence, and interpretation of the example sentence of an English word for which concentrated learning is currently being performed, are extracted from the local storage unit and are additionally displayed.

3. The English learning system according to claim 1, wherein:
the concentrated learning unit conducts a concentrated learning test after concentrated learning has been completed, the concentrated learning test is configured to randomly extract one English word from English words for which concentrated learning has been performed, present the extracted English word as a question, and present a Korean meaning corresponding to the extracted English word and Korean meanings randomly extracted from the local storage unit as examples, or is configured to randomly extract one English word from English words for which concentrated learning has been performed, present a Korean meaning corresponding to the extracted English word as a question, and present the extracted English word and English words randomly extracted from the local storage unit as examples, and the concentrated learning test is conducted for all English words for which concentrated learning has been performed.

4. The English learning system according to claim 3, wherein:
the English learning apparatus further comprises a statistical processing unit, the statistical processing unit provides a percentage of correct answers for each date for which concentrated learning has been performed after the test, classifies English words that have been processed as correct answers or incorrect answers into predetermined subjects including one or more of a prefix, a suffix, a part of speech and a number of letters, and displays the classified English words.

5. The English learning system according to claim 3, wherein:
the local storage unit further stores an English learning level of the user, the English word list of the local storage unit further includes a level based on a degree of difficulty and a degree of importance associated with each English word, the English learning apparatus further comprises a level management unit, the level management unit is configured such that when the English learning level of the user has not yet been set and is not stored in the local storage unit, the level management unit conducts a level test, determines an English learning level of the user according to a resulting test score, and stores the English learning level of the user in the local storage unit, and such that when the English learning level of the user has been previously set and is stored in the local storage unit, the level management unit promotes the English learning level of the user according to a resulting test score from the concentrated learning test, the level test is configured to randomly extract one English word from an English word list selected by the user, present the extracted English word as a question, and present a Korean meaning corresponding to the extracted English word and Korean meanings randomly extracted from the local storage unit as examples, or is configured to randomly extract one English word from the English word list selected by the user, present a Korean meaning corresponding to the extracted English word as a question, and present the extracted English word and English words randomly extracted from the local storage unit as examples, and the schedule management unit divides only English words corresponding to the English learning level of the user, stored in the local storage unit, among individual dates and allocates the divided English words to the corresponding dates.

6. The English learning system according to claim 1, wherein the concentrated learning unit applies a background color to an area in which an English word or a Korean meaning is displayed in a direction from left to right when the English word or the Korean meaning is displayed, wherein speed of application of the background color is proportional to a number of letters.

7. The English learning system according to claim 1, wherein:
the concentrated learning unit applies a background color to an area in which an English word or a Korean meaning is displayed in a direction from left to right when the English word or the Korean meaning is displayed, wherein speed of application of the background color is proportional to a number of letters, and the background color is implemented as different colors according to a forgetting period of Hermann Ebbinghaus.

8. The English learning system according to claim 1, wherein:
the English learning apparatus further comprises a pop quiz unit, the pop quiz unit conducts a pop test by randomly extracting one English word from English words for which concentrated learning was previously conducted at arbitrary time while the concentrated learning is being performed, and the pop test is configured to present the extracted English word as a question and present a Korean meaning corresponding to the extracted English word and Korean meanings randomly extracted from the local storage unit as examples, or is configured to present a Korean meaning corresponding to the extracted English word as a question and present the extracted English word and English words randomly extracted from the local storage unit as examples.

9. The English learning system according to claim 8, wherein the pop quiz unit conducts the pop test by randomly extracting one word from English words which are learned on a date corresponding to a forgetting period of Hermann Ebbinghaus, among dates on which the concentrated learning was previously performed.

10. The English learning system according to claim 1, wherein:
the English learning apparatus further comprises a biorhythm unit, the biorhythm unit calculates physical, emotional and intellectual levels of the user for individual dates according to a date of the user's birth, and the schedule management unit divides English words into different numbers of English words among individual dates depending on the physical, emotional and intellectual levels of the user, which have been calculated for the individual dates, and allocates the different numbers of English words to the corresponding dates.

11. An English learning apparatus, comprising:
a local storage unit for storing a user-created word list and an English word list, the English word list including dictionary data about each English word, and image data and sound data associated with the English word;
a local communication unit for receiving the user-created word list from a second server storage unit via a server communication unit and a computer network, and storing the user-created word list in the local storage unit;
a schedule management unit for dividing English words, included in a list selected by an input unit from among the user-created word list and the English word list which are stored in the local storage unit, among individual dates and allocating the divided English words to corresponding dates; and
a concentrated learning unit for performing concentrated learning on individual dates using a method of extracting English words allocated to a date selected by the input unit, and Korean meanings and images corresponding to the English words from the local storage unit and of displaying the English words, the Korean meanings and the images, wherein the schedule management unit equally divides English words among individual dates and allocates equal numbers of English words to corresponding dates, or, alternatively, divides English words according to a number of English words input by the input unit among individual dates, allocates the divided English words to the corresponding dates, and repeatedly allocates English words, which have been previously divided and allocated to the corresponding dates, to corresponding dates according to a forgetting period of Hermann Ebbinghaus, and wherein the concentrated learning unit sequentially displays each English word, an image, and a Korean meaning at predetermined time intervals, or simultaneously displays two of the English word, the image and the Korean meaning and subsequently displays a remaining one after a predetermined time interval.
